(19) United States
(12) Patent Application Publication
(10) Pub. No.: US 2002/0069150 A1
(43) Pub. Date: Jun. 6, 2002

(54) System and method to retain customers using rebate in combination with investment instruments to serve customers' long term financial needs

(76) Inventor: Biao Ni, Ballwin, MO (US)

Correspondence Address: Biao Ni, 324 Hill Trail Drive, Ballwin, MO, 63011, US

(21) Appl. No.: 10/008,320

(22) Filed: Nov. 8, 2001

Related U.S. Application Data
(60) Provisional application No. 60/251,109, filed on Dec. 4, 2000.

(51) Int. Cl. G06F 17/60

(52) U.S. Cl. 705/36

(57) ABSTRACT

Embodiments of a method of conducting a customer-retaining program of the present invention are disclosed comprising the steps of establishing a credit based account or a bank account with the sponsor of the incentive program for the benefit of a customer, providing to the customer an investment account employing a customer-chosen investment instrument which is arranged by the sponsor, funding the investment account, for the benefit of the customer, by sponsor-offered rebate which is determined by a predetermined but periodically adjustable percentage of the total amount of money that the customer has paid for purchasing goods or services from a merchant through the credit based account or the bank account established with the sponsor in a particular period of time, periodically transferring the amount of the rebate to the customer's investment account or, if there requires a division of the rebate which depends on the number of years of participation in the incentive program, periodically transferring a portion of the amount of the rebate to the customer's investment account while depositing the rest of the amount of the rebate temporarily into a match account which employs the same investment instrument that the customer chose for his or her investment account. Moreover, disclosed is an additional step providing a merchant offered rebate to the customer for purchasing goods or services from the merchant. Embodiments of a system of supporting a customer-retaining program are also disclosed. The system includes a means for collecting and storing transactional information which further includes customer identification information gathered by an identification means, a computer data processing device which consists of a centralized data storage device with a data input device, a centralized data processing center which is loaded with software programs for calculating the amount of the rebate offered by the sponsor of the incentive program to a customer as well as generating promotion materials for the purpose of informing the customer about the availability of the incentive program, at least one distributed data storage device with a data input device and such a distributed data storage device is in communication with the centralized data storage device and the centralized data processing center via an electronic data transmission device, a means for transferring funds, a means for reporting the rebate amount to the customer, and a means for promoting the customer-retaining program to the customer. In addition, if a merchant offers a rebate to the customer for purchasing the merchant's goods or services, a means for calculating the amount of the rebate offered by the merchant and a means for reporting the merchant offered rebate amount to both the customer and the merchant are included in the system.

### FIELD OF THE INVENTION

The present invention relates to a customer-retaining program supported by a computerized system with a method incorporating a rebate offered by a sponsor of the incentive program with an investment account, which employs an investment instrument chosen by a customer, to serve as a supplement in fulfilling the customer's retirement funding or other financial needs. More specifically, the present invention relates to a method for operating a customer-retaining program whereby a rebate in combination with an investment account is used to provide a substantive monetary reward to customers over time while retaining them to conduct business with the sponsor of the incentive program. The present invention also relates to a computerized system which, in supporting a customer-retaining program, periodically calculates expected future value of a customer-chosen investment account and incorporates such a value based on a certain rate of return with historic market benchmark statistics into promotion materials as well as regular account statements to inform a customer about the opportunity of accumulating a large amount of financial assets at no cost to the customer. The computerized system also periodically calculates and transfers to a customer-chosen investment account a rebate based on the total value of all transactions paid through a customer account, which can be a credit based account or a bank account, established with the sponsor of the incentive program.

### BACKGROUND OF THE INVENTION

It is always a major concern for any business entity in a competitive environment to earn more business from customers by maintaining a relationship with them. A variety of incentive systems have long been used to encourage existing or potential customers to enter into transactions with the sponsor who employs the incentive system. These incentive systems include advertisement of the difference in prices for similar goods or services, coupon, merchandise award, prize-winning game, credit toward near-future purchase, cash award, free trip, redeemable flight mileage, etc. It is apparent that all these incentive systems tend to focus on selling more goods or services at present by providing a short-term benefit to customers instead of earning their business over time by maintaining a relationship with them for a considerable number of years up to their lifetime.

Recent development in prior art starts to link patronage incentive award to customers' retirement security, but the emphasis of such an incentive system has not been shifted to maintain a relationship with customers for a long time and render convenience, choice and control to customers. Customers are unable to utilize such an incentive system by spending at their own discretion, i.e., making purchases on whatever they need or like regardless of suppliers of the goods or services. Another development in prior art intends to encourage customers simply to spend more today in order to earn rebates for the funding of their children's educational expenses rather than to spend based on rational decisions that in turn are solely determined by customer's needs. A seemingly unrealistic estimate for the possible accumulated assets within a not very long time period is used in such a development in prior art to convince an ordinary family with an average income that simply spending more today is effective. It is extremely difficult to reach that asset-accumulation level for the majority of average-income families, therefore it will bring disappointments to most customers and will not truly serve their various long term financial needs.

Increased life expectancies along with predictions of the insolvency of the social security system in the near future have indeed awakened many people in their needs to accumulate funds for their retirement years. Other developments in prior art tend to address problems relating to the accumulation of funds for a customer's retirement and other long-term financial needs, such as lack in the discipline of saving, inability to utilize automatic payroll deduction, inflexibility of cash flow, and inadequate planning. One recent development in prior art links a credit card account to an Individual Retirement Account (IRA) employing a method of automatic fund transfer. One of the unintentional negative impacts of such a system is that it could force a customer through automatic transfer to save for retirement by paying much higher interests on current debts to credit card issuer. It also neglects complicated taxation consequences related to eligibility of setting up such an account or various deduction limits defined by relevant tax laws for funding such an account based on individual customer's income and unique financial situation.

Thus, there exists a need for a program, which provides a rebate based on the amount of current spending made by a customer, solely based on his or her needs or preferences, regardless of the suppliers of goods or services, and periodically transfers the rebate to a customer-chosen investment account as an incentive, to encourage a customer repeatedly conducting business with the sponsor of the incentive program.

The object of the present invention is to provide a system with a method of retaining customers for a considerable number of years up to their lifetime that overcomes the aforementioned problems of the prior art.

A further object of the present invention is to provide such a system with a method which utilizes periodic and automatic rebate-on-transaction finding of a customer-chosen investment account so that a customer is relieved from the overwhelming need of providing adequate finds for his or her long-term financial needs.

A further object of the present invention is to provide such a system with a method which periodically calculates and reports to a customer the expected future value of his or her investment account based on the amount of each rebate payment, number of years of rebate payment, and historic rate of return generated by the investment instrument that a customer has chosen along with market benchmark statistics and other investment related information in order to maintain or raise the customer's interests in pursuing his or her benefits by conducting business with the sponsor of the incentive program.

A further object of the present invention is to provide such a system with a method which gives a customer the full control not only on spending and investment instrument selection for future benefits, but also on tax considerations while relieving the sponsor from dealing with complex tax issues.

A further object of the present invention is to provide such a system with a method that allows the sponsor of the incentive program to use additional funds or a portion of its existing marketing budget as rebate payments to retain and attract customers for their business.

A further object of the present invention is to provide such a system with a method which allows the sponsor of the incentive program to determine the rebate as a percentage of the monetary value of transactions paid through a customer's credit based account or bank account established with the sponsor of the incentive program and to incorporate weighted factors, which are determined by years of participation in the program, into the calculation of actual rebate payments in a way to encourage a customer's continued participation in the program.

Other objects and features of the invention will become apparent from the following summary and description in conjunction with the accompanying drawings. The drawings are designed solely for purposes of illustration and not as a definition of the limits of the invention for which reference should be made to the appended claims.

### SUMMARY OF THE INVENTION

The present invention provides a novel system with a novel method using rebate-on-transaction to fund a customer-chosen investment account that addresses a customer's long-term financial needs while attracting a customer to pursue his or her future benefits by repeatedly conducting business with the sponsor of the incentive program.

In accordance with the principles of the present invention, a method is disclosed in which a rebate is calculated and transferred to a customer-chosen investment account for each time period, normally a calendar year, and periodic calculation of expected future value of a customer's investment account is made and reported to the customer along with historic and market benchmark statistics.

A system of supporting such a customer-retaining program of the present invention is also disclosed.

The present invention comprises a system with a method that allows a rebate provided by the sponsor of the incentive program to be transferred to a customer-chosen investment account and to a match account subject to predetermined weighted factors based on years of participation in the program. In some of these embodiments, the sponsor may periodically, say annually, adjust the ratio of rebate to the aggregate value of transactions paid through a customer's account established with the sponsor of the incentive program within a given time period such as a calendar year. In some of these embodiments, the sponsor may adjust weighted factors in a fashion of pre-announcement. In some of these embodiments, the sponsor may have customers to agree on meeting a minimum value requirement when opening a customer-chosen investment account, provided an assigned type of investment account is available if the minimum value requirement is not met.

The present invention comprises a system with a method which also periodically calculates the expected future value of a customer's investment account based on the amount of each rebate payment, number of years of rebate payment, and historic rate of return generated by the investment instrument that a customer has chosen, and reports the expected future value to the customer along with market benchmark statistics and other investment related information. In some of these embodiments, if the sponsor also operates the supporting computerized system, it may incorporate such calculated results, statistics and information into existing monthly, quarterly, and annual account reports with some distinguished features to heighten a customer's awareness of potentially significant future value accumulations in his or her investment account over time.

The present invention comprises a system with a method which allows a customer to set up an investment account based on his or her choice of investment instrument with a sponsor-arranged financial institution (which could be a mutual fund, a bank, a savings and loan association, an insurance company, a broker-dealer, a credit union, or any other entity authorized by law to sell investment products to the general public) provided he or she first establishes a customer account, which is a credit based account or a bank account, with the sponsor of the incentive program. The system transfers the rebate earned by a customer to the customer's investment account and reports the transfer to the customer while leaving any tax considerations related to such an account to the customer so as to simplify the operation of account maintenance and truly render the full control to the customer. In some of these embodiments, an investment account could be a mutual fund account with a different perspective in terms of investment purposes as well as risks and returns involved. In some of these embodiments, an investment account could also be a bank account, an annuity policy, or a life insurance policy with asset-accumulation features. A customer can dedicate the status of his or her investment account as regular, regular IRA(contribution and accumulation tax deferred), or Roth IRA (contribution taxable, accumulation tax free), a portion of a SEP or a 401(K) plan, based on his or her income level and other financial situations. In one embodiment, a sponsor such as a bank or a business entity that issues credit cards and offers credit card services as well as banking services and investment services could itself be the financial institution which provides such investment services to the customer. In some of these embodiments, a customer account could be a personal checking account or a similar account carrying checking-writing feature with a bank, or a credit card account with a credit card issuer.

The system with the method of the present invention can be adapted for use by a single sponsor or a sponsor with one or more participating merchants, who are the suppliers or providers of goods or services, offering additional merchandise-or-service-specific rebate. In some of these embodiments, a sponsor could also be a mortgage company, a hotel chain, an airline, a department store chain, a discount store chain, a grocery store chain, a car dealer chain, or a gambling-entertainment resort chain who tailors the system and the method to target customers who repeatedly purchase goods or services from the sponsor of such an incentive program. Those merchants could choose not to be a sole sponsor of such an incentive program by participating in a bank sponsored or a credit card issuer sponsored program with specific rebates solely on purchases of goods or services that they offer.

### DESCRIPTION OF THE DRAWINGS

With reference to the figures herein, the preferred embodiment of the present invention will now be described in detail.

Business Relationship

FIG. 9 is a block diagram which shows the business relationships among the sponsor of such an inventive program, a customer, a third-party financial institution (it can be an investment service division of the sponsor or an independent investment company), and various merchants or service providers.

The sponsor B12 who, in a preferred embodiment, is primarily a bank or a credit card issuer, solicits the promotion of free lifetime reward using rebate in combination with asset accumulation through investment to a customer B22.

The customer B22 opens a customer account which can be a bank account or a credit card account with the sponsor and an investment account with one of the provided financial institutions which can be an affiliated investment service division of the sponsor or an independent third-party financial company. A customer pays a purchase of any goods or services from any merchant or service provider B32, who accepts a credit card charge or a bank account check as the means of payment, by charging to the customer's credit card account or by bank account check payment.

A merchant B32 submits customer's credit card charges or personal checks to the sponsor B12. In return, the sponsor, upon verification, bills that customer for the charges accrued in his or her credit card account in a particular period of time, or transfers funds from that customer's bank account to the merchant as payment and reports to both the customer and the merchant regarding the transaction. In one embodiment, one or more of the merchants can join the sponsor to offer additional rebates on its own goods or services. The sponsor can include such merchant-specific rebate information in promotion materials for a fee or for free.

The sponsor B12 sends to the customer an account statement, which includes regular balance and transaction details, with additional information on rebate amount, expected future value of customer-chosen investment account funded by rebate, and related promotion messages revealing the compounding power of investment assets over time. At the end of a pre-announced time period, usually a calendar year, the sponsor transfers the rebate to an investment account chosen by the customer at the sponsor's affiliated division of investment services B42 or at a third-party financial institution B43 while the sponsor may temporarily deposit a portion of the rebate, based on weighted factors which in turn depend on the number of years of participation, into a match account employing the same type of investment instrument.

The sponsor B12 opens a match account at each and every financial institution at which at least one customer has chosen to open an investment account. One embodiment is that customer A chooses a mutual fund I of focusing on growth, customer B and customer C choose a mutual fund II of focusing on the technology sector, and customer D chooses a mutual fund III of focusing on government bonds. The sponsor has one account opened at each and every mutual fund I, II, and III so that the rate of return and risks associated with a chosen investment instrument will be exactly the same as those carried by a customer's investment account. This process ensures that a customer obtains the full benefits as well as undertakes the entire risks arising from the chosen investment instrument. Eventually this portion of invested rebates with accumulated returns or losses is to be transferred to the customer's investment account after a certain time period, say five or ten years determined by the weighted factor schedule. The purpose of the temporary withholding of a portion of rebates in a match account is to encourage a customer to remain in the program as long as possible.

The sponsor's division of investment services B42 or the third-party financial institution B43 sends regular periodic reports to the customer who holds a rebate-funded investment account.

System

FIG. 10 shows a block diagram of a preferred embodiment of a computerized system of the present invention. Such a computerized system has identification means S10 that is used to identify a customer who pays or charges a purchase from any merchant or service provider through the customer's account established with the sponsor of the incentive program. The identification means S10 can be any tangible item capable of storing information, such as a bank check with identification information printed onto it or a plastic card with identification information recorded in magnetic or some other machine readable form. One example is a credit card or a credit card-like device. The identification means S10 contains identification information S12 that identifies a customer.

The computerized system includes transactional information S14 which comprises identification information and information that describes features of a transaction such as the monetary value of the transaction, the date of the transaction, the identity of the merchant.

This computerized system includes one or more remote data input devices SH2D for inputting the transactional information into distributed data storage devices SH4D that are connected to centralized data storage device SH4 and centralized data processing center SH6 through networks, telephone lines, Internet, or other electronic data transmission devices. A remote data input device SH2D may include an electronic card reader, a scanner, a computer keyboard or any other means known to one skilled in the art of inputting information into computer data storage memories.

Such a computerized system also includes expected account value calculation for promotion S20 and rebate calculation information S30. Expected account value calculation for promotion S20 includes but is not limited to historic rate of return generated by a customer-chosen investment instrument, number of inputs, amount of each input, present value of assets in the account, and holding period of investment. Rebate calculation information S30 comprises a sponsor-specified percentage point that determines the rebate based on the monetary value of a transaction and an optional merchant-specified rebate percentage point based on the monetary value of a purchase of goods or services offered by that merchant. In other embodiments a rebate can be based on the number of transactions or purchases instead of on the monetary value of transactions.

The computerized system further includes weighted factor information S40 which is used to determine the cash value of a rebate to be redeemed at a particular time or a portion of the rebate that can be transferred to a customer's investment account at a particular time while the rest of the rebate is temporarily held in a match account until a customer's account has maintained a valid status longer than a pre-announced time period. Weighted factors are designed in a biased way to encourage a customer pursuing own benefits by keeping rebate in his or her investment account, in the meantime the sponsor retains the customer for additional business.

A data input device SH2 is used to input information including expected account value calculation for promotion S20, rebate calculation information S30, and weighted factor information S40 into centralized data storage device SH4. Also included in this computerized system is a centralized data processing center SH6. The centralized data processing center may be any electronic computer such as a mainframe computer, a network server computer, a work station computer or a personal computer. Such a computerized system further comprises one or more software programs SS2 which are used to determine the rebate amount in a particular period of time and to calculate the expected value of an investment account using historic market average rate of return as well as a series of assumed rate of return for a customer's reference and to perform other data processing needs.

The centralized data processing center SH6, which is loaded with software programs SS2, is in communication with the centralized data storage device SH4 as well as with distributed data storage devices SH4D where all needed information including identification information, transactional information, expected account value calculation information for promotion, rebate calculation information, and weighted factor information are stored so that the centralized data processing center is able to perform three main tasks. First, to generate promotion materials S52 with the expected value calculation for a typical investment account revealing the compounding power of invested assets. The promotion materials are known to customers through promotion means S50 that can be advertisements on TV, Internet, radio, or through mailing, posting, direct marketing as well as other channels. Second, to calculate a rebate amount S60 that is to be awarded to a customer. After performing a rebate pay out preparation at S62 using weighted factors, the rebate is paid as weighted-factor discounted cash payment S68 if a customer chooses not to invest, or a portion of the rebate determined by the weighted factor is transferred directly to a customer's investment account S66a and the rest is temporarily deposited to a match account S66b through funds transferring means S64. This preferred embodiment includes a funds transfer means S64 which can be any means for transferring monetary funds between a first monetary account or a monetary reserve and a second monetary account known to one skilled in the art of the field. One example is an electronic funds transfer system. The match account S66b is an account employing the same investment instrument that a customer chose for his or her individual investment account. Third, to generate corresponding reports for customer S72 and merchant S74, and to deliver them through reporting means S70.

Process and Method

FIG. 1—Overall Process

FIG. 1 shows a flow chart describing the overall process and method of the present invention of a customer-retaining program. The promotion material preparation routine H12 that is to be explained in detail in FIG. 6 produces marketing materials to convey the idea that a rebate funded investment account could accumulate a considerable amount of financial assets over time while it costs nothing to a customer.

Any change to rebate percentage (%) and other account agreements, or to optional merchant-offered rebate percentage (%) and related requirements are updated in the promotion material preparation routine H12 from the reward account maintenance and report routine H72 through connector \mathring{A}. Promotion materials are distributed which is shown as H21 and customer applications are received and processed which is shown as H33 through manual operation or other means. One embodiment is to use printed copies through mailing or to use fly sheets at stores and other places in a similar fashion. One other embodiment is to use electronic copies posted on one or more Internet sites for viewing or free downloading. Any customer reply to the request made after initial application evaluation for additional information is also received and processed which is shown as H31 through manual operation or other means. Request for additional information, one of the steps performed in the reward account maintenance and report routine H72, is connected to customer replies received H31 through connector \mathring{B}.

An inquiry is made at step H40 to determine if a customer has applied to be enrolled in rebate-funded-investment program. If the answer to this inquiry is negative, then the process continues to step H51 where an existing regular account maintenance and report routine performs all the tasks for regular customer account setup, maintenance and reporting.

If the answer to the inquiry at step H40 is affirmative, then the choice of investment account type made by a customer is identified at step H62. There are different kinds of investment instruments that can be included in the rebate-funded-investment program by the sponsor of such an incentive program including but not limited to various mutual funds, annuities, life insurance policies embedded with cash value, and Certificate of Deposits (CDs). In one embodiment there is a variety of mutual funds ranging from stock funds, which include growth, income, international, sectors, and other types, to bond funds, which include governmental, municipal, corporate, high yield, and other types, as well as Certificate of Deposits to be offered as available investment instruments. In one other embodiment, not only a variety of mutual funds with distinguished types as well as investment objectives and Certificate of Deposits are offered as investment instruments, but also various annuities and life insurance products are included for the purpose of serving a customer's long-term financial needs.

The process then proceeds to the reward account maintenance and report routine at step H72 which is shown in FIG. 2 that is to be explained in detail below.

FIG. 6—Promotion Material Preparation Routine

The promotion material preparation routine H12 is shown by the flow chart of FIG. 6. At step P12, a customer-retaining program that is known to a customer as a rebate-funded-investment program with a campaign slogan “Your Big Bucks Free” is announced to attract a customer's attention.

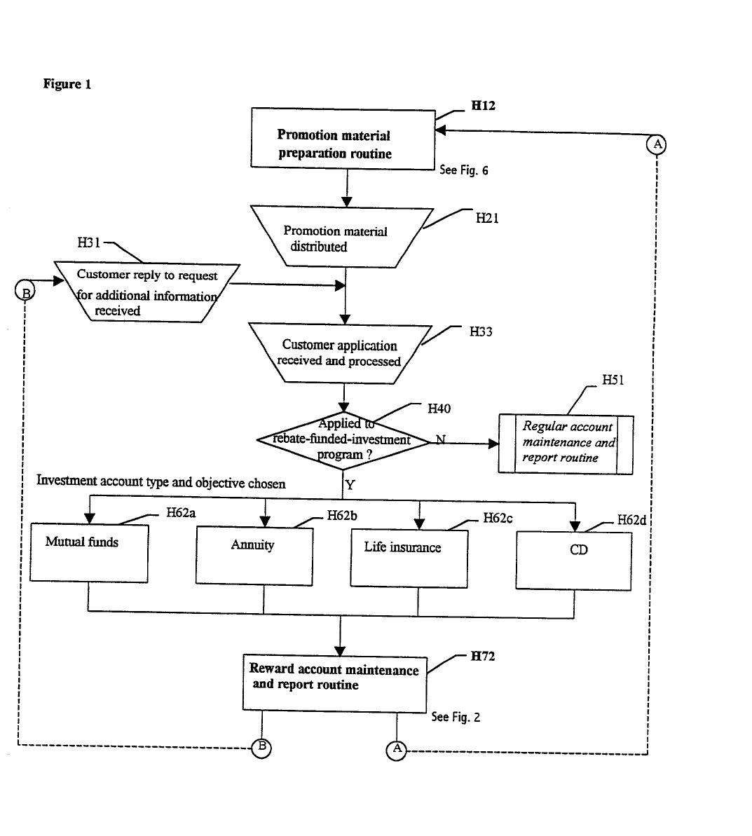

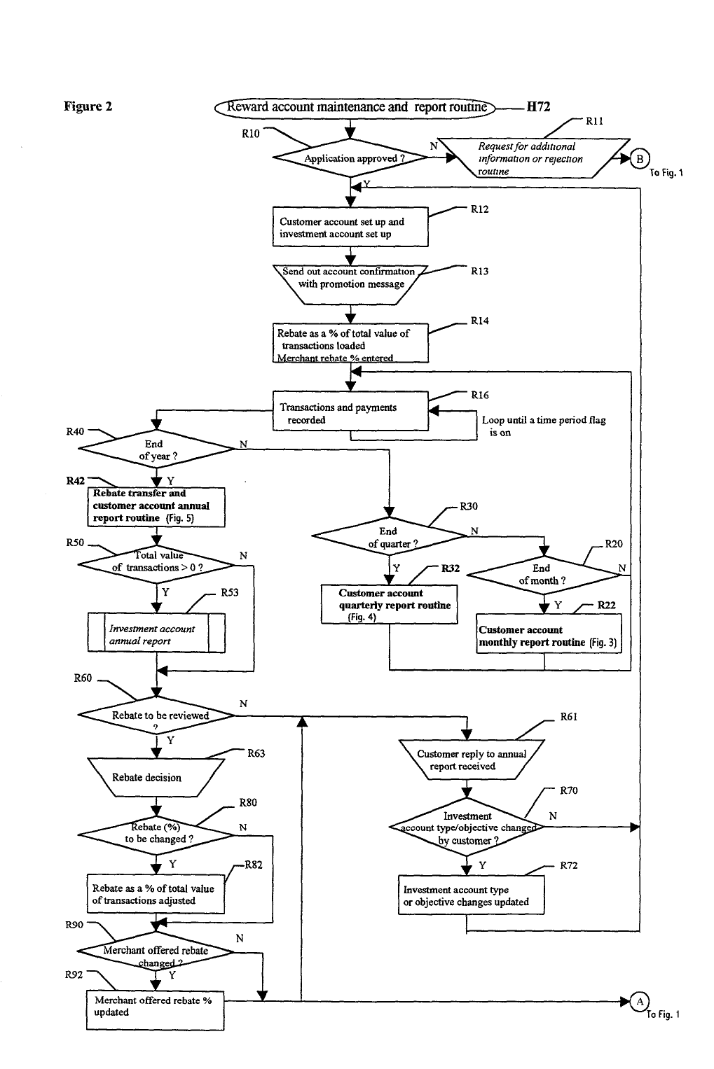

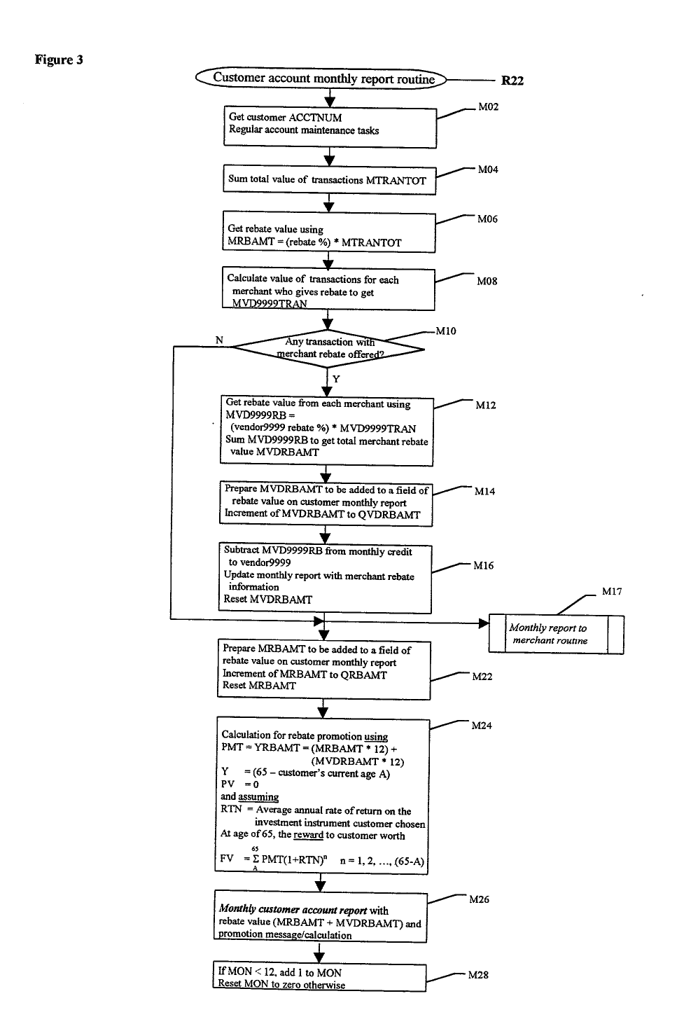

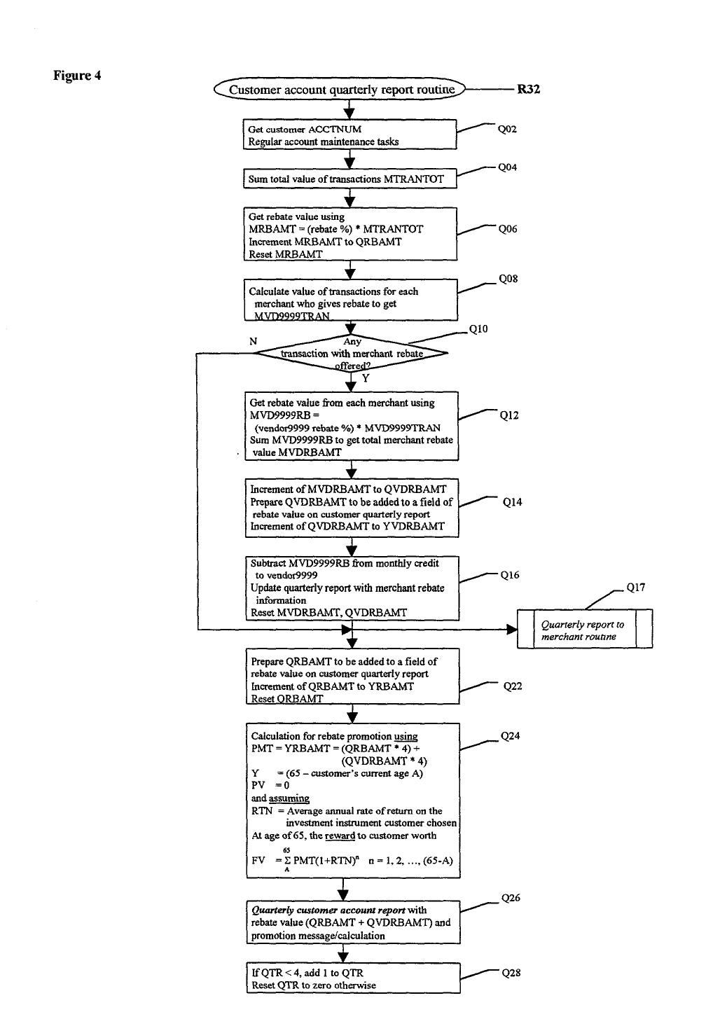

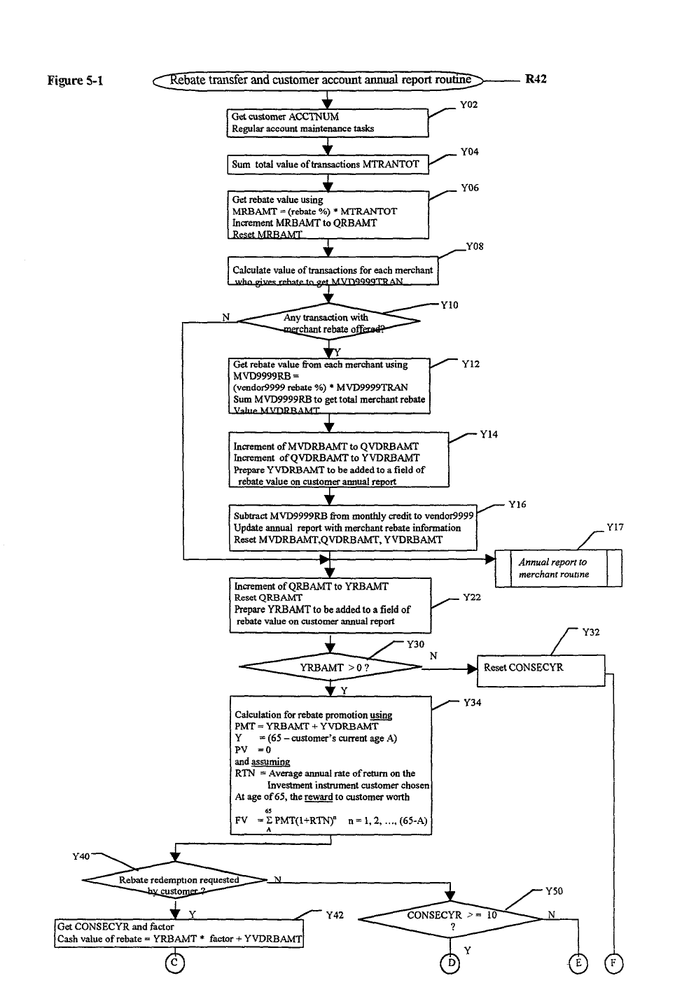

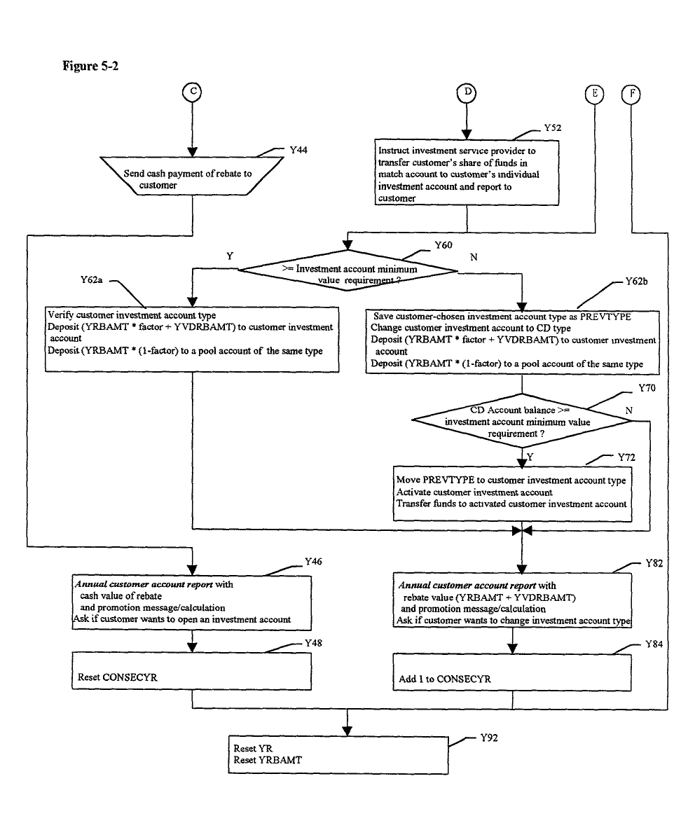

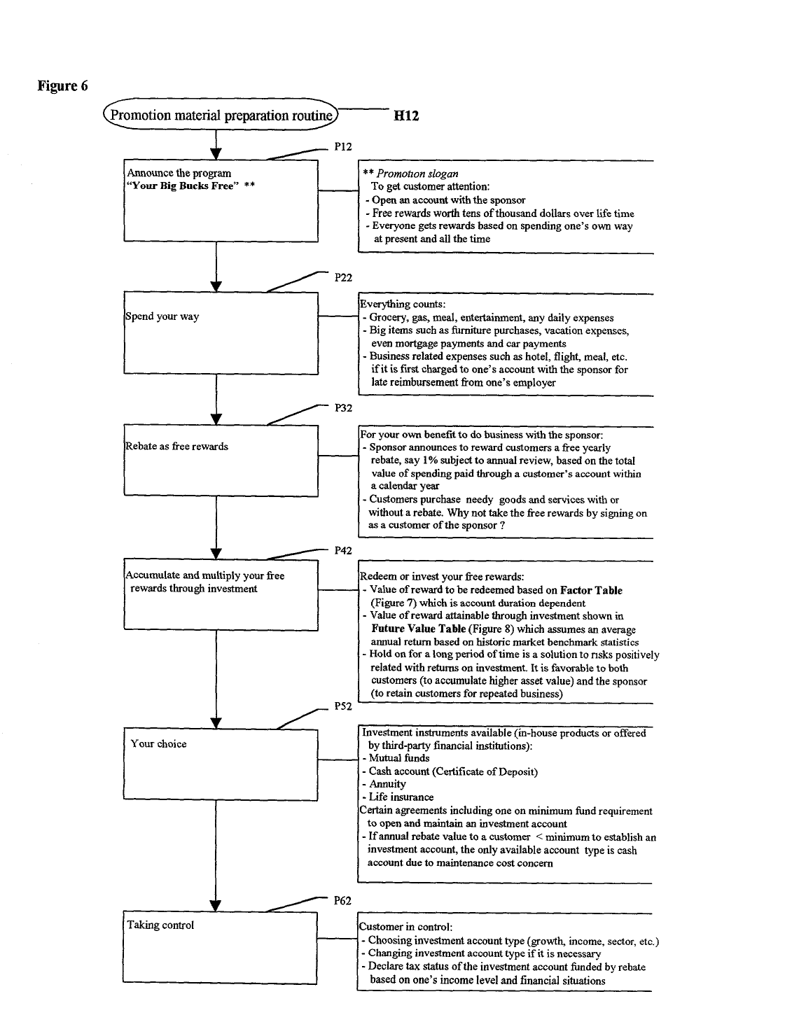

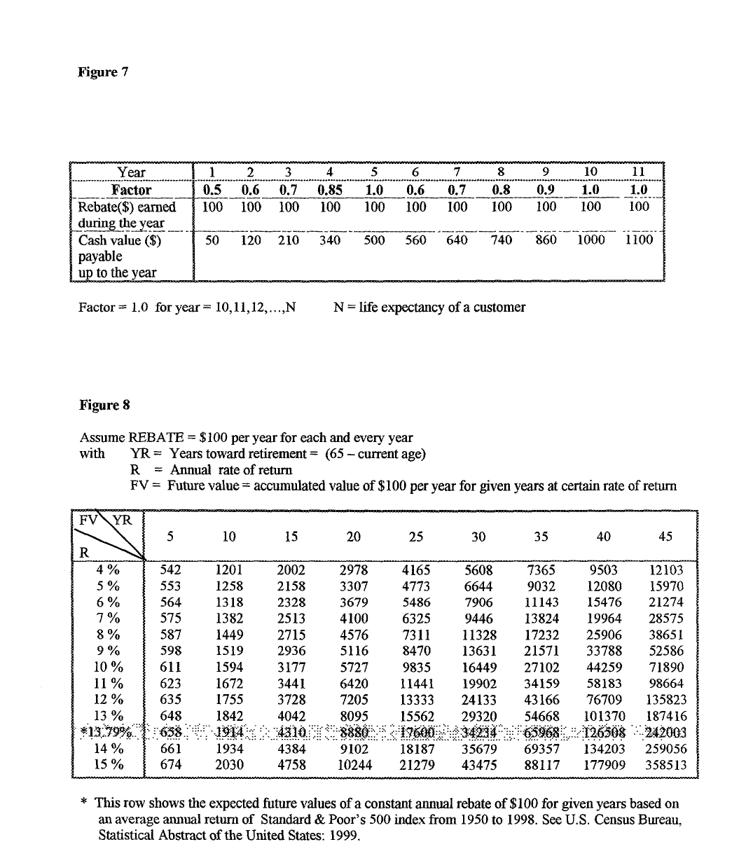

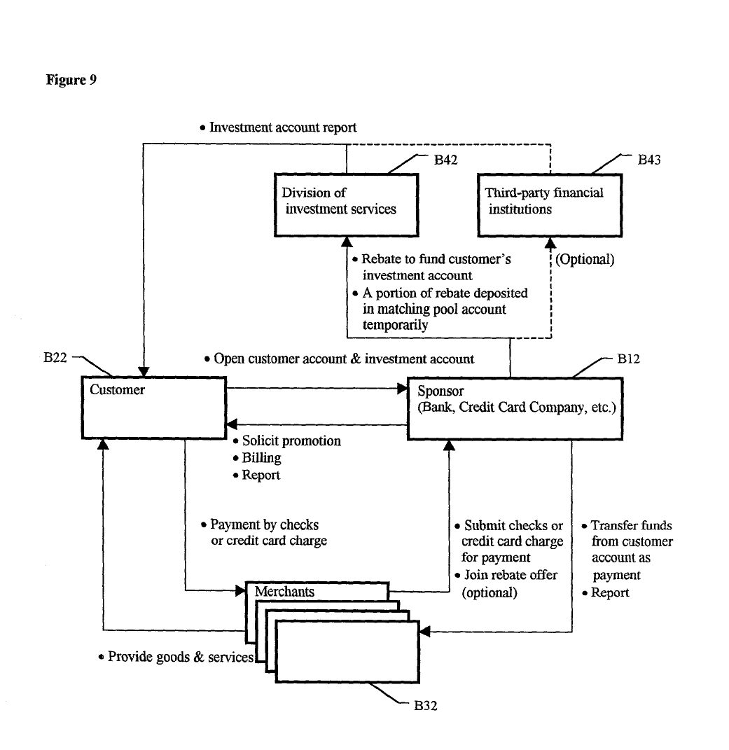

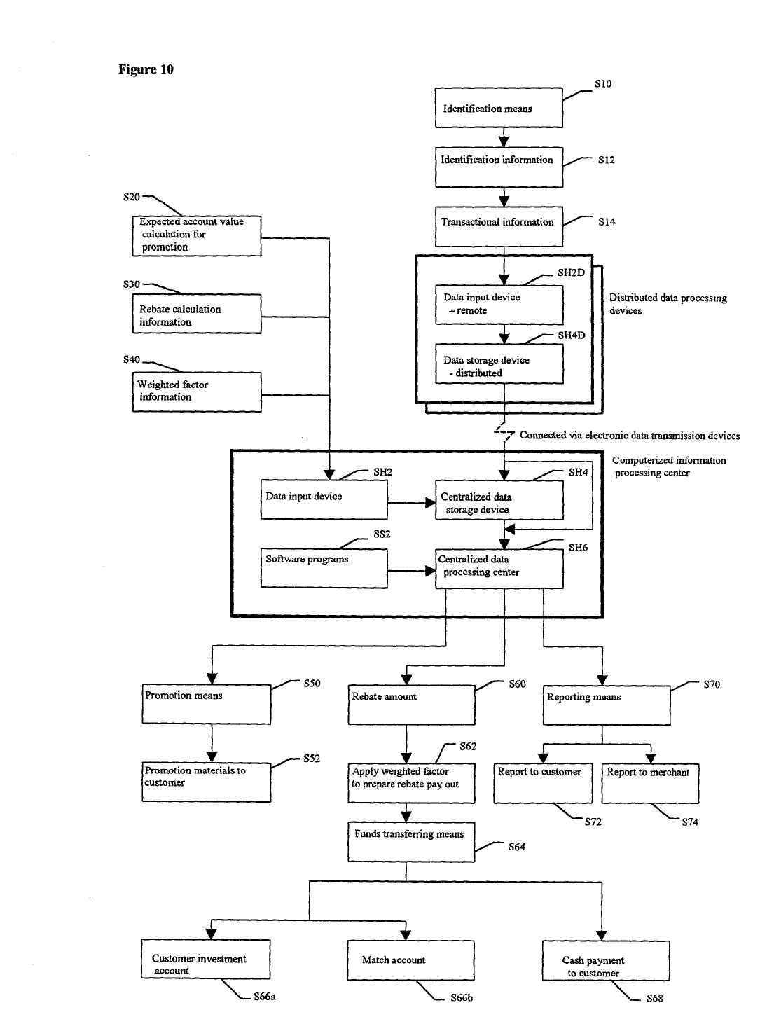

A customer (B22 in FIG. 9) opens and maintains a customer account, which can be a credit card account or a bank account, with the sponsor (B12 in FIG. 9) and a rebate-funded investment account with the division of investment services of the sponsor (B42 in FIG. 9) or with a sponsor-arranged third party financial institution (B43 in FIG. 9). Each and every payment of purchased goods or services through the customer's account with the sponsor of the incentive program is rewarded a rebate which is paid periodically, usually once a year at the end of a calendar year, to fund the above mentioned customer-chosen investment account. To the contrary of existing prize-winning promotion where very few participants win the rewards because of extremely low winning probability, the present invention of customer-retaining program rewards everyone based solely on the amount of payment through one's customer account with the sponsor of the incentive program.

At step P22, the theme “spend your way” is explained in detail. There is no restriction attached to exclude any purchase paid through above mentioned customer account from earning rebate. A customer truly spends at his or her own discretion based only on individual needs and preferences. Everything ranging from daily needs to big item purchases even business-related expenses is counted for a rebate if it is paid through the customer's account with the sponsor of the incentive program.

At step P32, the nature of the rebate is explained. The sponsor of the incentive program rewards a rebate using additional funds or a portion of an existing marketing budget so it is entirely free to a customer. The sponsor of the incentive program announces to reward customers a pre-determined rebate, say 1% subject to annual review, of the amount of each transaction paid through the above mentioned customer account with the sponsor of the incentive program. Because each and every purchase of goods or services is determined by a customer's individual needs, a customer will and do spend money on these items with or without a rebate as long as the needs exist. It is better off for a customer to establish a customer's account with the sponsor of the incentive program to take the advantage of using free rebate to fund his or her investment account. It is also a golden opportunity for the sponsor of the incentive program to retain a stable and ever expanding customer base. Such a customer base can also be used attracting merchants to offer merchant-specific rebate and other promotions or as a fee-based channel to bring in advertisement income.

At step P42, the advantage of maintaining a customer account with the sponsor of the incentive program for a long time is explained to a customer, in particular, a real possibility to accumulate a large amount of financial assets over time without additional costs to a customer is highlighted. The customer could redeem earned rebate at present or in a relatively short time period. A factor table, which is described in FIG. 7, determines the cash value of earned rebate at redemption. The weighted factors are designed in a way to encourage a customer to maintain a customer account for at least ten years. For example, a rebate in the amount of $100 at the end of the current calendar year can be redeemed for $50 in cash based on the factor of 0.5 for year one. Assuming that a customer earns a rebate of $100 every year in two consecutive years and leaves the first-year rebate in cash account (no interest payment to the first year earned rebate for a simplified illustration), the customer can redeem all the rebates at the end of the second calendar year. In this case a total nominal amount of $200, for $120 in cash based on the factor of 0.6 for year two. If a customer decides to put the first year earned rebate into investment, an amount of $50, or 50% of the rebate worth of $100 will be transferred to his or her investment account based on the factor of 0.5 for year one. The rest of the rebate will be temporarily deposited into a sponsor-holding match account which matches a customer's account with the same investment instrument (mutual fund, annuities, life insurance product, or Certificate of Deposit, etc.) and the same type or objective (growth, income, sector, etc.) at the same financial institution. At the end of second calendar year, an amount of $60, or 60% of the earned rebate worth of $100 again will be transferred to his or her investment account based on the factor of 0.6 for year two, and the rest of that year's earned rebate will be deposited into above mentioned match account. If a customer for some reason decides to redeem all of earned rebate, the customer can redeem the earned rebate in second calendar year for $60 in cash and obtain the market value of all shares in his or her investment account with the market closing price at the redemption date. The weighted factor converges to 1.0 in year ten and stands as a constant thereafter. If a customer has maintained an active and valid customer account with the sponsor of the incentive program for ten years, the customer could redeem the earned rebate at 100% of its value in cash or have the earned rebate to be transferred at 100% to his or her investment account. In addition, all temporarily withheld finds in the match account belonging to the customer will be transferred to his or her individual investment account when the weighted factor reaches 1.0. There is no withholding after ten years.

The process at step P42 then proceeds to demonstrate a table of expected future values, which is shown in FIG. 8, with an assumption that a rebate of $100 is earned for each and every year. If the annual rebate of $100 from all the years are invested and all possible dividends and capital gains are reinvested in the same investment account with annual rate of return at a constant 10%, after 35 (thirty five) years, such an investment account would have accumulated $27,102. It is a large, but not unattainable number. For a customer of age 30 earning an annual rebate of $100, which requires to spend $10,000 on daily needs and other expenses within a year and those spending to be paid through his or her customer account with the sponsor of the incentive program, he or she could expect, at the retirement age of 65 (sixty five) or 35 (thirty five) years later, to take home $27,102 (before tax) for free if the annual rate of return generated by the customer-chosen investment instrument keeps at the same rate of 10%. In reality the rate of return fluctuates year by year. However, the actual historic average annual rate of return from 1950 to 1998 based on Standard & Poor' 500 Index is 13.79% (See U.S. Census Bureau, Statistical Abstract of the United States: 1999), a number that is above the hypothetical 10% level. Therefore it is very possible to reach or exceed that impressive amount of $27,102 for a customer who is committed to the above mentioned rebate-funded-investment program by investing all the rebates in the market from present to his or her retirement age. While revealing the compounding power of investment return over time, the positive correlation between the rate of return and risks associated with any investment decision is emphasized as an equally important message. The solution is to diversify and to hold on for a long time. Such a solution works both for a customer who could have accumulated a considerable amount of financial assets over time and for the sponsor of the incentive program who could have retained a large number of customers for years.

At step P52, a customer is presented with an opportunity to choose from a variety of investment instruments. These investment instruments can be offered by the investment service division of the sponsor or by third party financial institutions through the arrangement of the sponsor. A customer is also aware of an agreement on minimum fund requirement for opening and maintaining an investment account due to concerns of account maintenance costs. If the value of the rebate earned by a customer is less than the required minimum value to establish a customer-chosen investment account, the only available investment account type is Certificate of Deposit. The customer's investment account type can be changed back automatically to the type chosen by him or her if the total value of funds in above mentioned Certificate of Deposit account plus recently earned rebate equals or exceeds the required minimum value of establishing an investment account.

At step P62, it confirms that a customer takes full control on his or her spending which are paid through the customer account established with the sponsor as well as in all aspects including tax related considerations about his or her investment account arranged through the sponsor. The customer makes purchase decisions only on his or her individual needs and preferences. The customer chooses investment instrument type and objective for his or her own investment account. It is equally important that the customer takes care of tax concerns on his or her investment account funded by the earned rebate. Such an investment account can be declared as a regular IRA (Individual Retirement Account), a Roth IRA, a supplementary account to any kind of retirement accounts including but not limited to 401(k) and SEP plan, or simply a regular investment account. Since everyone's financial situation is different, it is beneficial to a customer to take control over his or her financial aspects and related tax concerns while alleviating the burden for the sponsor to deal with tax related account maintenance and reporting required by laws and government regulations.

FIG. 2—Reward Account Maintenance and Report Routine

The reward account maintenance and report routine H72 is shown by the flow chart of FIG. 2.

An inquiry is made at step R10 to determine if an application submitted by a customer is approved.

If the answer to the inquiry made at step R10 is negative, then the process continues to step R11 where a request for additional information or a rejection is sent to a customer. The connector \mathring{B} connects such a request or a rejection to any further reply from a customer H31 in FIG. 1.

If the answer to the inquiry made at step R10 is affirmative, the process then proceeds to steps R12 and R13, where both a customer account and a customer-chosen investment account are set up and the account confirmation is sent out with additional promotion messages. The process then proceeds to step R14 where annual rebate as a percentage of total value of transactions paid through a customer's account is loaded. Merchant-offered rebates, if there is any, are also entered at this step. Next, the process proceeds to step R16 where each and every transaction along with corresponding payment information is recorded until a time-period-flag (month, quarter, or year) to be trigged periodically.

At step R40, an inquiry is made to determine if the end of a calendar year is reached.

If the answer to the inquiry made at step R40 is negative, then the process proceeds to step R30, where another inquiry is made to determine if the end of the current quarter is reached.

If the answer to the inquiry made at step R30 is negative, then the process proceeds to step R20, where again another inquiry is made to determine if the end of the current month is reached.

If the answer to the inquiry made at step R20 is negative, then the process proceeds to step R16 continuing the loop to record additional transactions and payments.

If the answer to the inquiry made at step R20 is affirmative, then the process proceeds to the customer account monthly report routine at step R22 which is shown in FIG. 3 that is to be explained in detail below. After processing the monthly maintenance and reporting, the process goes back to step R16 to start the next run of the loop to record incoming transactions and payments.

Let us return to step R30. If the answer to the inquiry made at step R30 is affirmative, then the process proceeds to the customer account quarterly report routine at step R32 which is shown in FIG. 4 that is to be explained in detail below. After processing the quarterly maintenance and reporting, the process goes back to step R16 to start the next run of the loop to record incoming transactions and payments.

Let us further return to step R40. If the answer to the inquiry made at step R40 is affirmative, then the process proceeds to the rebate transfer and customer account annual report routine R42 which is shown in FIG. 5 that is to be explained in detail below. After processing the annual reporting and rebate find transfer, the process further proceeds to step R50 where another inquiry is made to determine if the total value of transactions paid through a customer's account with the sponsor of the incentive program during the calendar year is great than zero.

If the answer to the inquiry made at step R50 is negative, then the process proceeds directly to step R60.

If the answer to the inquiry made at step R50 is affirmative, then the process proceeds to step R53 where an existing routine is performed, usually by an investment service provider, to generate and send out an investment account annual report to a customer, and the process continues to proceed to step R60.

At step R60, an inquiry is made to determine if the rebate as a percentage (%) of the total value of transactions is to be reviewed.

If the answer to the inquiry made at step R60 is negative, then the process proceeds to step R61 where customer replies, if there is any, to annual report are received and processed. The process continues to proceed to step R70 where another inquiry is made to determine if investment account type or objective is changed by a customer.

If the answer to the inquiry made at step R70 is negative, then the process proceeds to step R12 to be ready for next time period.

If the answer to the inquiry made at step R70 is affirmative, then the process proceeds to step R72 where changes to one's investment account requested by a customer are updated. The process continues to proceed to step R12 to be ready for next time period.

Let us return to step R60. If the answer to the inquiry made at step R60 is affirmative, then the process proceeds to step R63 where a decision on rebate is made by the management authority of the sponsor. The process continues to proceed to step R80 where another inquiry is made to determine if rebate as a percentage (%) of the total value of transactions paid through a customer's account with the sponsor is changed.

If the answer to the inquiry made at step R80 is negative, then the process proceeds directly to step R90.

If the answer to the inquiry made at step R80 is affirmative, then the process proceeds to step R82 where rebate as a percentage (%) of the total value of transactions paid through a customer's account with the sponsor is adjusted. The process proceeds to step R90.

At step R90, a further inquiry is made to determine if one or more merchant-offered rebates are changed.

If the answer to the inquiry made at step R90 is negative, then the process proceeds to step R61 as well as to step R12 in FIG. 1 through connector \mathring{A} where rebate information is updated.

If the answer to the inquiry made at step R90 is affirmative, then the process proceeds to step R92 where changes made to merchant-offered rebates are updated. The process continues to proceed to step R61 as well as to step R12 in FIG. 1 through connector \mathring{A} where rebate information is updated.

FIG. 3—Customer Account Monthly Report Routine

The customer account monthly report routine, which is step R22 in FIG. 2, is shown by the flow chart of FIG. 3.

At step M02, a customer account number ACCTNUM is identified and a series of regular account maintenance tasks such as calculation of debt, credit, and current balance to the account during the month are performed.

The process then proceeds to step M04 where the total value of transactions paid through the customer account during the month MTRANTOT is calculated by summing up all paid transactions within the month.

The process then proceeds to step M06 where the sponsor-offered rebate value MRBAMT for the month is obtained through multiplying monthly total transaction value MTRANTOT by predetermined rebate rate, say 1%.

The process further proceeds to step M08 where the value of transactions with each merchant, MVD9999TRAN, is summed up separately within this customer's account. The four 9's in MVD9999TRAN represents a four-digit merchant number. For example, if a customer purchased goods or services worth of $500 from merchant 0015 and worth of $1,100 from merchant 8057 during the month, then the process obtains and store MVD0015TRAN=$500 and MVD8057TRAN=$1,100.

The process continues to proceed to step M10 where an inquiry is made to determine if a transaction is eligible to earn any merchant-offered rebates.

If the answer to the inquiry made at step M10 is negative, then the process proceeds to step M17 to provide updated transaction information for existing routine of monthly report to merchant as well as to step M22 to continue the remaining tasks of the customer account monthly report routine.

If the answer to the inquiry made at step M10 is affirmative, then the process proceeds to step M12 where the value of rebate offered by a particular merchant, MVD9999RB, is obtained through multiplying monthly transaction value with this merchant MVD9999TRAN by the merchant-specific rebate rate (%). Using the above mentioned examples of transaction value $500 with merchant 0015 and transaction value $1,100 with merchant 8057 and assuming merchant 0015 and 8057 to offer the respective rebates of 1% and 2%, then the process obtains and stores MVD0015RB=$5 and MVD8057RB=$22. A monthly total merchant rebate value for this customer account MVDRBAMT is also calculated at step M12 by adding up all individual MVD9999RB where 9999 stands for various merchant numbers.

The process further proceeds to step M14 where the monthly total merchant rebate value MVDRBAMT is copied to a temporary storage space for being included in the forthcoming monthly customer account report and to be added to the quarterly total merchant rebate value QVDRBAMT.

The process continues to proceed to step M16 where monthly customer account report is updated with merchant rebate information. Each merchant-specific rebate MVD9999RB is subtracted from the credit to be paid to the merchant. The monthly total merchant rebate value MVDRBAMT is reset to zero afterwards.

Following step M16 the process proceeds to step M17 to provide updated transaction and rebate information for existing routine of monthly report to merchant as well as proceeds to step M22 to continue the remaining of the tasks of the customer account monthly report routine.

At step M22, the sponsor-offered rebate value for the month MRBAMT is copied to a temporary space for being included in the forthcoming monthly customer account report and is reset to zero after being added to the quarterly total sponsor rebate value QRBAMT.

The process continues to proceed to step M24 where an expected future value for the customer's investment account FV at the account owner's retirement age is calculated to periodically refresh the idea of accumulating large amount of financial assets without costs that is highlighted in promotion materials. The calculation is based on assumptions that the customer continues to earn the same amount of monthly rebate over time to give the constant future input PMT, and the annual rate of return, RTN, generated by the customer-chosen investment instrument in future years equals to the average historic rate of return generated by the same investment instrument. The number of years, Y, used in the formula is determined by subtracting the customer's current age from the legal retirement age of 65 (sixty-five). The present value, PV, is set to zero since it costs nothing to the account owner who is the customer.

The process further proceeds to step M26 where monthly report is produced with sponsor-offered rebate value MRBAMT and merchant-specific rebate, if there is any, MVDRBAMT as well as calculated account future value and other promotion messages included.

The process proceeds to step M28 where a counter for number of months MON is increased by 1 (one) if MON is less than 12 (twelve), otherwise MON is reset to zero.

The reports both at step M17 and at step M26 can be printed statements sent through post mail or electronic files accessible through Internet web sites for viewing or downloading.

FIG. 4—Customer Account Quarterly Report Routine

The customer account quarterly report routine, which is step R32 in FIG. 2, is shown by the flow chart of FIG. 4.

At step Q02, a customer account number ACCTNUM is identified and a series of regular account maintenance tasks such as calculation of debt, credit, and current balance of the account during the last month of the quarter are performed.

The process then proceeds to step Q04 where the total value of transactions paid through the customer account during the last month of this quarter MTRANTOT is calculated by summing up all paid transactions within the month.

The process then proceeds to step Q06 where the sponsor-offered rebate value MRBAMT for the last month of this quarter is obtained through multiplying monthly total transaction value MTRANTOT by predetermined rebate rate, say 1%. The newly calculated MRBAMT is reset to zero after being added to a quarterly total sponsor rebate value QRBAMT.

The process further proceeds to step Q08 where the value of transactions with each merchant during the last month of this quarter, MVD9999TRAN, is summed up separately within this customer's account. The four 9's in MVD9999TRAN represents a four-digit merchant number. For example, if a customer purchased goods or services worth of $500 from merchant 0015 and $1,100 from merchant 8057 during the month, then the process obtains and store MVD0015TRAN=$500 and MVD8057TRAN=$1,100.

The process continues to proceed to step Q10 where an inquiry is made to determine if a transaction is eligible to earn any merchant-offered rebates.

If the answer to the inquiry made at step Q10 is negative, then the process proceeds to step Q17 to provide updated transaction information for existing routine of quarterly report to merchant as well as proceeds to step Q22 to continue the remaining tasks of the customer account quarterly report routine.

If the answer to the inquiry made at step Q10 is affirmative, then the process proceeds to step Q12 where the value of rebate offered by a particular merchant, MVD9999RB, is obtained through multiplying monthly transaction value with this merchant MVD9999TRAN by the merchant-specific rebate rate (%). Using the above mentioned example of transaction value $500 with merchant 0015 and transaction value $1,100 with merchant 8057 and assuming merchant 0015 and 8057 to offer the respective rebates of 1% and 2%, then the process obtains and stores MVD0015RB=$5 and MVD8057RB=$22. A monthly total merchant rebate value for this customer account MVDRBAMT is also calculated at step Q12 by adding up all individual MVD9999RB where 9999 stands for various merchant numbers.

The process further proceeds to step Q14 where the monthly total merchant rebate value MVDRBAMT is added to quarterly merchant rebate value QVDRBAMT, which is in turn copied to a temporary storage space for being included in the forthcoming quarterly customer account report and to be added to an annual total merchant rebate value YVDRBAMT.

The process continues to proceed to step Q16 where quarterly customer account report is updated with merchant rebate information. Each merchant-specific rebate MVD9999RB is subtracted from the credit to be paid to the merchant. The monthly total merchant rebate value MVDRBAMT and the quarterly total merchant rebate value QVDRBAMT are reset to zero afterwards.

Following step Q16 the process proceeds to step Q17 to provide updated transaction and rebate information for existing routine of quarterly report to merchant as well as proceeds to step Q22 to continue the remaining of the tasks of the customer account quarterly report routine.

At step Q22, the sponsor-offered rebate value for the quarter QRBAMT is copied to a temporary space for being included in the forthcoming quarterly customer account report and is reset to zero after being added to an annual total sponsor rebate value YRBAMT.

The process continues to proceed to step Q24 where an expected future value for the customer's investment account FV at the account owner's retirement age is calculated to periodically refresh the idea of accumulating large amount of financial assets without costs that is highlighted in promotion materials. The calculation is based on assumptions that the customer continues to earn the same amount of quarterly rebate over time to give the constant future input PMT, and the annual rate of return, RTN, generated by the customer-chosen investment instrument in future years equals to the average historic rate of return generated by the same investment instrument. The number of years, Y, used in the formula is determined by subtracting the customer's current age from the legal retirement age of 65 (sixty-five). The present value, PV, is set to zero since it costs nothing to the account owner who is the customer.

The process further proceeds to step Q26 where quarterly report is produced with sponsor-offered rebate value QRBAMT and merchant-specific rebate, if there is any, QVDRBAMT as well as calculated account future value and other promotion messages included.

The process proceeds to step Q28 where a counter for number of quarters QTR is increased by 1 (one) if QTR is less than 4 (four), otherwise QTR is reset to zero.

The reports both at step Q17 and at step Q26 can be printed statements sent through post mail or electronic files accessible through Internet web sites for viewing or downloading.

FIG. 5—Rebate Transfer and Customer Account Annual Report Routine

The rebate transfer and customer account annual report routine, which is step R42 in FIG. 2, is shown by the flow chart of FIG. 5.

At step Y02, a customer account number ACCTNUM is identified and a series of regular account maintenance tasks such as calculation of debt, credit, and current balance of the account during the last month of the year are performed.

The process then proceeds to step Y04 where total value of transactions paid through the customer account during the last month of the year MTRANTOT is calculated by summing up all paid transactions within the month.

The process then proceeds to step Y06 where the sponsor-offered rebate value MRBAMT for the last month of this year is obtained through multiplying monthly total transaction value MTRANTOT by predetermined rebate rate, say 1%. The newly calculated MRBAMT is reset to zero after being added to QRBAMT.

The process further proceeds to step Y08 where the value of transactions with each merchant during the last month of the last quarter of the year, MVD9999TRAN, is summed up separately within this customer's account. The four 9's in MVD9999TRAN represents a four-digit merchant number. For example, if a customer purchased goods or services worth of $500 from merchant 0015 and worth of $1,100 from merchant 8057 during the month, then the process obtains and store MVD0015TRAN=$500 and MVD8057TRAN=$1,100.

The process continues to proceed to step Y10 where an inquiry is made to determine if a transaction is eligible to earn any merchant-offered rebates.

If the answer to the inquiry made at step Y10 is negative, then the process proceeds to step Y17 to provide updated transaction information for existing routine of annual report to merchant as well as proceeds to step Y22 to continue the remaining of the tasks of the rebate transfer and customer account annual report.

If the answer to the inquiry made at step Y10 is affirmative, then the process proceeds to step Y12 where the value of rebate offered by a particular merchant, MVD9999RB, is obtained through multiplying monthly transaction value with this merchant MVD9999TRAN by the merchant-specific rebate rate (%). Using the above mentioned examples of transaction value $500 with merchant 0015 and transaction value $1,100 with merchant 8057 and assuming merchant 0015 and 8057 to offer the respective rebates of 1% and 2%, then the process obtains and stores MVDOO15RB=$5 and MVD8057RB=$22. A monthly total merchant rebate value for this customer account MVDRBAMT is also calculated at step Y12 by adding up all individual MVD9999RB where 9999 stands for various merchant numbers.

The process further proceeds to step Y14 where the monthly total merchant rebate value MVDRBAMT is added to the quarterly merchant rebate value QVDRBAMT, which is in turn to be added to the annual total merchant rebate value YVDRBAMT. YVDRBAMT is copied to a temporary storage space for being included in the forthcoming annual customer account report.

The process continues to proceed to step Y16 where annual customer account report is updated with merchant rebate information. Each merchant-specific rebate MVD9999RB is subtracted from the credit to be paid to the merchant. The monthly total merchant rebate value MVDRBAMT, the quarterly total merchant rebate value QVDRBAMT, and the annual total merchant rebate value YVDRBAMT are reset to zero afterwards.

Following step Y16 the process proceeds to step Y17 to provide updated transaction and rebate information for existing routine of annual report to merchant as well as proceeds to step Y22 to continue the remaining of the tasks of the rebate transfer and customer account annual report routine.

At step Y22, the sponsor-offered rebate value for the quarter QRBAMT is reset to zero after being added to the annual total sponsor rebate value YRBAMT which is in turn to be reset to zero after being copied to a temporary space for being included in the forthcoming annual customer account report and for the next inquiry.

The process proceeds to step Y30 where an inquiry is made to determine if annual total sponsor rebate value YRBAMT is greater than zero.

If the answer to the inquiry made at step Y30 is negative, then the process proceeds to step Y32 where a counter for consecutive years of account activity CONSECYR is reset to zero. The process then proceeds directly to step Y92 through the connector \mathring{F}. At step Y92, the counter for number of years YR is reset to zero and annual total rebate value YRBAMT is reset to zero.

If the answer to the inquiry made at step Y30 is affirmative, then the process proceeds to step Y34 where an expected future value for the customer's investment account FV at the account owner's retirement age is calculated to periodically refresh the idea of accumulating large amount of financial assets without costs that is highlighted in promotion materials. The calculation is based on assumptions that the customer continues to earn the same amount of annual rebate over time to give the constant future input PMT, and the annual rate of return, RTN, generated by the customer-chosen investment instrument in future years equals to the average historic rate of return generated by the same investment instrument. The number of years, Y, used in the formula is determined by subtracting the customer's current age from the legal retirement age of 65 (sixty-five). The present value, PV, is set to zero since it costs nothing to the account owner who is the customer.

The process continues to proceed to step Y40 where an inquiry is made to determine if a customer requests a redemption of the rebate.

If the answer to the inquiry made at step Y40 is negative, then the process proceeds to step Y50 where another inquiry is made to determine if the counter of consecutive years of account activity CONSECYR is greater than or equal to 10 (ten years).

If the answer to the inquiry made at step Y50 is negative, then the process proceeds to step Y60 through the connector \mathring{E}.

If the answer to the inquiry made at step Y50 is affirmative, then the process proceeds, through the connector \mathring{D}, to step Y52 where an instruction is sent to investment service provider asking to transfer a customer's shares in the match account to the customer's individual investment account and to report to the customer. The process then proceeds to step Y60.

Let us return to step Y40. If the answer to the inquiry made at step Y40 is affirmative, then the process proceeds to step Y42 where the cash value of the rebate is calculated through multiplying total annual sponsor rebate value YRBAMT by one of the weighted factors, which in turn is determined by consecutive years of account activity CONSECYR (see FIG. 7), then adding the annual total merchant rebate value YVDRBAMT.

The process continues to proceed to step Y44 through connector \mathring{C} to send cash payment of the rebate to a customer.

The process proceeds further to step Y46 where annual report is produced including sponsor-offered rebate value YRBAMT and its cash redemption value, merchant-specific rebate value YVDRBAMT, if there is any, as well as calculated possible account future value if a customer would have chosen to invest and other promotion messages. A customer is also asked if he or she chooses to open an investment account.

The process proceeds to step Y48 where the counter for consecutive years of account activity CONSECYR is reset to zero.

The process then proceeds to step Y92 where the counter for number of years YR is reset to zero and annual total sponsor rebate value YRBAMT is also reset to zero.

Let us go back to step Y60. At step Y60, an inquiry is made to determine if the minimum value requirement for opening a customer-chosen investment account is met.

If the answer to the inquiry made at step Y60 is negative, then the process proceeds to step Y62b where the investment account type chosen by a customer is saved as PREVTYPE, and the current type of customer's investment account is changed to CD (Certificate of Deposit) type. A portion of the rebate value based on one of the weighted factors is transferred to the customer's investment account; the rest is deposited into the match account of the same type.

The process then proceeds to step Y70 where an inquiry is made to determine if the value of a customer's CD (Certificate of Deposit) type investment account is greater than or equal to the minimum value required for opening a customer-chosen investment account.

If the answer to the inquiry made at step Y70 is negative, then the process proceeds directly to step Y82.

If the answer to the inquiry made at step Y70 is affirmative, then the process proceeds to step Y72 where the type of a customer's investment account is updated to PREVTYPE, which is the type originally chosen by the customer. Funds in the customer's CD (Certificate of Deposit) type investment account are transferred to such a newly activated investment account. The process continues to proceed to step Y82.

Let us go back to step Y60. If the answer to the inquiry made at step Y60 is affirmative, the process proceeds to step Y62a where a portion of the rebate value based on one of the weighted factor is transferred to a customer's investment account after account type verification, the rest is deposited into a match account of the same type. The process continues to proceed to step Y82.

At step Y82, the annual report is produced including sponsor-offered rebate value YRBAMT, merchant-specific rebate value YVDRBAMT, if there is any, as well as calculated account future value and other promotion messages. A customer is also asked if he or she wants to change his or her investment account type or objective.

The process proceeds to step Y84 where the counter for consecutive years of account activity CONSECYR is updated by adding 1 (one) to it.

The process continues to proceed to step Y92 where the counter for number of years YR is reset to zero and annual total rebate value YRIBAMT is also reset to zero.

The reports at step Y17, step Y46, and step Y82 can be printed statements sent through post mail or electronic files accessible through Internet web sites for viewing or downloading.

I claim:

1. A method of conducting an incentive program of retaining a customer using a rebate offered by a sponsor in combination with an investment account employing an investment instrument serving said customer's long term financial needs, said method comprising the steps of:
a) establishing a credit based account with said sponsor for the benefit of said customer, or
a′) establishing a bank account with said sponsor for the benefit of said customer;
b) providing an investment account employing said investment instrument arranged by said sponsor;
c) funding said investment account of said customer using said rebate offered by said sponsor with a predetermined but periodically adjustable percentage of total amount of money that said customer has paid for purchasing goods or services from a merchant through said credit based account or said bank account in a particular period of time; and
d) electronically transferring the amount of said rebate in a particular period of time to said investment account of said customer if a division of the amount of said rebate is not necessary, or
d′) electronically transferring a portion of the amount of said rebate in a particular period of time to said investment account of said customer and the rest of said rebate in a particular period of time to a match account, said match account employs the same said investment instrument as those selected by said customer for said investment account, if a division of the amount of said rebate is needed.

2. The method of claim 1 further comprising the step of promoting the establishment of said investment account funded with said rebate offered by said sponsor for the benefit of said customer.

3. The method of claim 2 further including a table of expected future values of a constant annual rebate for various lengths of time period based on different assumed annual rates of return and a historic market average annual rate of return, said table reveals the fact of asset accumulation over time.

4. The method of claim 2 further comprising the step of communicating the idea of funding said investment account using said rebate offered by said sponsor serving long term financial needs of said customer by
e) incorporating said promotion of the establishment of said investment account into existing periodic reports operated by said sponsor serving said credit based account or said bank account of said customer; or
e′) marketing said promotion of the establishment of said investment account separately to reach said customer.

5. The method of claim 1 further comprising the steps of:
f) ascertaining the total amount of money charged to said credit based account or paid through said bank account by said customer for purchasing goods or services provided by said merchant in a particular period of time;
g) calculating an amount of said rebate using said predetermined percentage based on said total amount of money charged to said credit based account or paid through said bank account by said customer in a particular period of time so ascertained; and
h) incorporating a statement of said calculated rebate of said period of time into existing periodic reports operated by said sponsor serving said credit based account or said bank account of said customer; or
h′) reporting a statement of said calculated rebate of said period of time separately to said customer.

6. The method of claim 1 further comprising the step of including a specific rebate offered by said merchant to said customer for purchasing goods or services provided by said merchant.

7. The method of claim 6 further comprising the steps of:
i) ascertaining the total amount of money charged to said credit based account or paid through said bank account by said customer for purchasing goods or services provided by said merchant offering said merchant specific rebate in a particular period of time;
j) calculating an amount of said merchant specific rebate using a merchant specified percentage based on said total amount of money charged to said credit based account or paid through said bank account by said customer for purchasing goods or services provided by said merchant offering said merchant specific rebate in a particular period of time so ascertained;
k) subtracting the amount of said calculated merchant specific rebate from periodic credit to said merchant in a particular period of time;
l) electronically transferring the amount of said merchant specific rebate in a particular period of time to said investment account of said customer; and
m) incorporating a statement of said calculated merchant specific rebate in a particular period of time into existing periodic reports operated by said sponsor serving said merchant; or
m′) reporting a statement of said calculated merchant specific rebate in a particular period of time to said merchant separately.

8. The method of claim 1 further comprising the step of determining if said customer has made payments through said credit based account or said bank account for a period longer than a predetermined number of years.

9. The method of claim 8 further including a table of a series of real cash values of a constant annual rebate weighted by numeric factors depending on number of years that said customer holds said credit based account or said bank account with a valid account status, said table using said weighted numeric factors determines said portion of the amount of said rebate in a particular period of time to be transferred to said investment account of said customer and the rest of said rebate in a particular period of time to be temporarily deposited into said match account if said division of said rebate is needed.

10. The method of claim 8 further comprising the step of establishing said match account only when said customer has maintained and made payments through said credit based account or said bank account for a period less than said predetermined number of years.

11. The method of claim 1 further comprising the steps of:
n) instructing an investment service provider of said investment instrument to transfer funds from said match account to said investment account of said customer at request; and
o) requiring said provider of said investment instrument to report to said customer regarding said fund transfer from said match account to said investment account of said customer.

12. The method of operating a customer retaining program described in claim 1, wherein said investment instrument can be mutual funds, annuities, life insurance policies with embedded cash values, certificate of deposit, securities, and other financial devices accumulating monetary values over time.

13. A computerized system for supporting an incentive program of retaining a customer using a rebate offered by a sponsor in combination with an investment account employing an investment instrument serving said customer's long term financial needs, said system comprising:
a) a means for collecting and storing transactional information;
b) a computer data processing device;
c) a means for electronically transferring an amount of said rebate in a particular period of time to said investment account of said customer employing said investment instrument if a division of the amount of said rebate is not necessary, or
c′) a means for electronically transferring a portion of the amount of said rebate in a particular period of time to said investment account of said customer employing said investment instrument and the rest of said rebate in a particular period of time to a match account, said match account employs the same said investment instrument as those selected by said customer for said investment account, if a division of the amount of said rebate is needed; and
d) a means for reporting the amount of said rebate funding said investment account in a particular period of time to said customer.

14. A computerized system for supporting a customer retaining program as described in claim 13, further comprising an identification means for identifying said customer who participates in a transaction by paying purchases of goods or services offered by a merchant through said credit based account or said bank account, said identification means having identification information about said customer, said customer having said investment account, and said merchant providing goods or services.

15. A computerized system for supporting an incentive program of retaining a customer as described in claim 13, wherein said transactional information including said identification information.

16. A computerized system for supporting an incentive program of retaining a customer as described in claim 13, wherein said computer data processing device comprising
e) a centralized data storage device including a data input device;
f) a computer data processing center;
g) at least one distributed data processing device including said data input device and a distributed data storage device, said distributed data storage device and said distributed data processing device being in communication with said centralized data storage device and said centralized data processing center via an electronic data transmission device; and
h) a software program for determining an amount of said rebate in a particular period of time.

17. A computerized system for supporting an incentive program of retaining a customer as described in claim 13 further comprising a means for reporting an amount of a merchant specific rebate in a particular period of time to said merchant, only when said merchant offering said merchant specific rebate.

18. A computerized system for supporting an incentive program of retaining a customer as described in claim 13 further comprising a means for promoting said customer retaining program using said rebate in combination with said investment account to said customer.
